(19) United States
(12) Patent Application Publication
(10) Pub. No.: US 2009/0089872 A1
(43) Pub. Date: Apr. 2, 2009

(54) Communication network access

(75) Inventors: Jari Arkko, Kauniainen (FI); Jan Melen, Espoo (FI); Teemu Rinta-Aho, Espoo (FI)

Correspondence Address: NIXON & VANDERHYE, PC, 901 NORTH GLEBE ROAD, 11TH FLOOR, ARLINGTON, VA, 22203, US

(73) Assignee: TELEFONAKTIEBOLAGET LM ERICSSON (PUBL), Stockholm (SE)

(21) Appl. No.: 12/219,457

(22) Filed: Jul. 22, 2008

Related U.S. Application Data
(63) Continuation of application No. PCT/EP2006/050357, filed on Jan. 23, 2006.

(51) Int. Cl. G06F 21/00

(52) U.S. Cl. 726/12

(57) ABSTRACT

A method of routing traffic between external users and a communication network via a private access network. The method comprises establishing a secure outer tunnel between the private network and a gateway of a public access network to which the private network is coupled, based upon authentication of the private network to the public access network, said gateway being coupled to said communication network. For each external user wishing to connect to the communication network via the private network, a secure inner tunnel is established between the user and the gateway based upon authentication of the user to the gateway, the inner tunnel being within said outer tunnel. Traffic is caused to flow between external users and the gateway through the respective inner tunnels.

### FIELD OF THE INVENTION

The present invention relates to a method and apparatus for facilitating access to a communication network. The invention is applicable in particular, though not necessarily, to facilitating access to a communication network via a wireless access network.

### BACKGROUND

Wireless access networks enable mobile users to access the services offered by a range of communication networks. A prime example of such a communication network is the Internet. Another example is a telephone network. Today, the most widely used wireless access networks are cellular telephone radio access networks such as are provided by the operators of GSM and 3G networks. These access networks are publicly available insofar as anyone having a valid subscription (including pre-paid accounts) can make use of the access network. Other types of wireless access networks are also available. For example, the introduction of WLAN networks in cafes, libraries, airports, etc, allows mobile users to make use of the WLAN services either free of charge or for a small fee.

### SUMMARY

The number of wireless access networks which could be used by roaming mobile users is much greater than the number which are actually used. Take for example the large number of home and corporate WLANs which are presently closed to users who do not “belong” to the homes or companies where the WLANs reside but which offer relatively high speeds and capacities. These are closed for a number of reasons including:
A private network owner does not want to allow others to take a free ride on his or her investment or worse, allow others to incur costs on the part of the private network owner;
In order to ensure that sufficient network capacity is available to home/company users;
To ensure that the access network is not used for illegal purposes; and
Technical reasons which make public access to private networks impractical.

As an example of a technical difficulty, one might consider a private network which requires that users be authenticated to it, in which case it may be necessary to configure a key in the roaming mobile terminals. Particularly in the case of home-based networks, this is not something that either the home owner (e.g. family) or mobile user would want to do (on a regular basis). It might of course be possible to allow private network operators to participate in existing roaming consortiums and to be set up with the necessary technology (based for example on the Authentication Authorisation and Accounting (AAA) standard). However, in practise this is unrealistic due to a number of technical and other limitations, namely:
Setting AAA connections is demanding even for experts, let alone the general public. The existing protocols require a large number of parameters to be agreed upon, particularly where RADIUS is used [IETF RFC2865].
The characteristics of AAA systems do not make them suitable for large scale roaming connections among multiple levels of players [I-D.ietf-eap-netsel-problem]. For instance, there is a lack of an automatic routing mechanism which forces transaction routing within the network of interconnected providers to be manually configured.
The commercial requirements for acceptance into a roaming consortium (or being able to provide “peering” over MA) are too high for most private networks. It is unlikely that a AAA proxy from a private network would be allowed to connect to the AAA network of a major provider, for instance.

Any solution which facilitates external access to a communication network via a private network should satisfy the following requirements:
Such network service should be arranged automatically, i.e., without the involvement of either the owner or the users (perhaps with the exception of turning the feature on).
Different compensation and business models should be supported, in case private network operators require compensation.
The solution should accommodate tracking of illegal activities to an extent similar to existing, commercially deployed Internet access solutions.
The solution should be suitable for both single-hop and multi-hop solutions, i.e. the entity providing network access can be either directly connected to a real public access network or gains access through some other private network(s).

According to a first aspect of the present invention there is provided a method of routing traffic between external users and a communication network via a private access network, the method comprising:
establishing a secure outer tunnel between the private network and a gateway of a public access network to which the private network is coupled, based upon authentication of the private network to the public access network, said gateway being coupled to said communication network;
for each external user wishing to connect to the communication network via the private network, establishing a secure inner tunnel between the user and the gateway based upon authentication of the user to the gateway, the inner tunnel being within said outer tunnel; and
causing traffic to flow between external users and the gateway through the respective inner tunnels.

The term “external users” encompasses a range of entities including but not limited to devices, subscribers utilising one or more devices, and SIM/USIM cards used in one or more devices.

Embodiments of the invention allow the public access network of the private network to determine exactly which traffic associated with external users is routed via the private network. This allows the public access network to, for example, allocate an appropriate monetary credit, or other bonus, to the private network operator. On the other hand, the public access network is able to determine the identity of the external user associated with particular traffic based upon the owner of the inner tunnel through which that traffic is carried.

It is the role of the private network to cause traffic received from an external user to flow through the outer tunnel. This involves encapsulating the received traffic according to the outer tunnel security procedures. Similarly, the private network decapsulates traffic arriving from the gateway and destined for an external user. The gateway on the other hand encapsulates and decapsulates according to both the inner and outer tunnels, whilst the external user encapsulates and decapsulates only according to the inner tunnel.

In some embodiments of the invention, the outer tunnel carries only traffic which travels through the inner tunnels. Other embodiments may allow the private network to send its own traffic through the outer tunnel, not within an inner tunnel. In this case, the gateway will recognise that this traffic belongs to the private network as it is not transported through an inner tunnel.

The communication network to which the private network facilitates access may be the Internet.

The public access network of the private network may be a fixed line or cellular telecommunications network.

Preferably, said outer and inner tunnels are IPSec tunnels defined by IKE SAs negotiated between the private network and a gateway of the public access network and between the external users and that gateway.

Authentication of an external user to a gateway may be performed within said public access network, or may involve the public access network communicating with a further network where the user is a subscriber of that further network.

In its simplest form, the private network is a single node attached to the public access network via a wireless or wired connection. The private network may also consist of a set of nodes internally connected over either wireless or wired links.

The invention is applicable in particular to private wireless networks. The private network may be a WLAN network, e.g. home or corporate, or a network provided by a single device having wireless connectivity. External users having appropriate wireless connectivity are allowed to roam between private wireless networks and public wireless networks such as GSM and 3G networks.

Said gateway may be configured to reject requests to establish secure tunnels with external users which will not pass through said external tunnel.

According to a second aspect of the present invention there is provided a gateway for controlling access by external users to a communication network, the gateway being located within a public access network, the gateway comprising:
means for establishing a secure outer tunnel between a private network and the gateway;
means for establishing a secure inner tunnel between each external user wishing to connect to the communication network via the private network and the gateway based upon authentication of the user to the gateway, the inner tunnel being within said outer tunnel; and
means for associating traffic travelling through an inner tunnel with a corresponding external user and with the private network.

According to a third aspect of the present invention there is provided a processing node for use within a private network for routing traffic between external users and a communication network via the private access network, the processing node comprising:
means for establishing a secure outer tunnel between the private network and a gateway of a public access network used by the private network based upon authentication of the private network to the public access network, said gateway being coupled to said communication network; and
means for routing all traffic originating at said external users through said outer tunnel.

### BRIEF DESCRIPTION OF THE DRAWINGS

FIG. 1 illustrates schematically a scenario where an external user accesses the Internet via a private network; and

FIG. 2 is a flow diagram illustrating a method for allowing an external user to access a communication network via a private access network.

### DETAILED DESCRIPTION

As has been set out above, it is desirable in some circumstances to allow a roaming mobile user possessing a wireless enabled (or possibly wireline connected) terminal, e.g. a smartphone, PDA, laptop, etc, to access a communication network via what is essentially a private access network. An example of a private network is a home or corporate WLAN. Suitable private networks will be connected to a public access network such as might be owned and operated by a telecommunication network operator to allow users to connect to the “outside world”. The private network operator will pay the telecommunication network operator for this service, typically on the basis of a regular subscription and/or a pay-per-use basis.

The definition of a private network encompasses the typical home and corporate WLANs. However, it also extends to encompass any suitable device or system that provides wireless coverage over a surrounding area. Examples include Bluetooth™ and WLAN enabled devices. The private network will establish a tunnel or tunnels with the public access network for routing traffic originating within the private network and destined for the private network, i.e. associated with the private networks own client(s), according to conventional practice.

A necessary preliminary step in the process of allowing roaming mobile (“external”) users to make use of a private access network is the setting up of an IP level tunnel (the “outer” tunnel) between the private network and its public access network. Such an IP tunnel means that the private network does not need to be directly connected to its public access network. This is relevant for example where the private network is provided by a device such as a smartphone or PDA which is able to connect to a public access network via a visited (or “foreign”) network. The tunnel is established using Internet Key Exchange (IKEv2) [I-D.ieff-ipsec-ikev2] to a gateway node within the public access network. The gateway node's address is either preconfigured or calculated according to some known procedure (see, e.g., [3GPP.24.234]). IKEv2 may possibly use its Extensible Authentication Protocol (EAP) mode so that typical network access credentials can be employed. For example, a cellular wireless LAN smartphone could use SIM or USIM cards to authenticate itself when attaching to a particular network as well as when communicating with the (IKEv2) gateway. This first run of the IKE procedure results in a pair of IKE Security Associations (SAs) being established between the private network and the public access network.

Access to the resources of the private network may be controlled by the private network operator to ensure that sufficient capacity is available for home users. However, when the resource situation allows, the private network may offer network access to other external mobile users. No authentication is required for these external users at the link layer (i.e. at establishment of a radio link between the external user and the private network). However, the private network forces all externally originating traffic through the established outer tunnel over the link between the private and public access network. In the same way, the gateway will force all traffic destined for an external user through the same tunnel. The appropriate processing node within the private network and the gateway perform reciprocal sender-receiver roles.

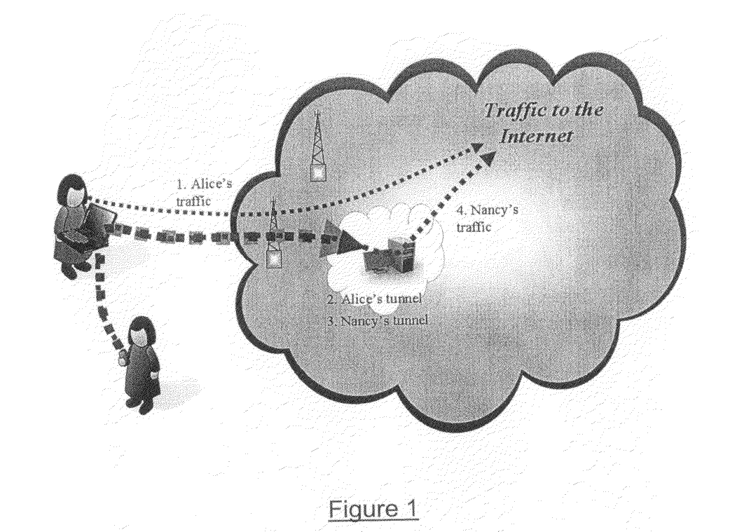

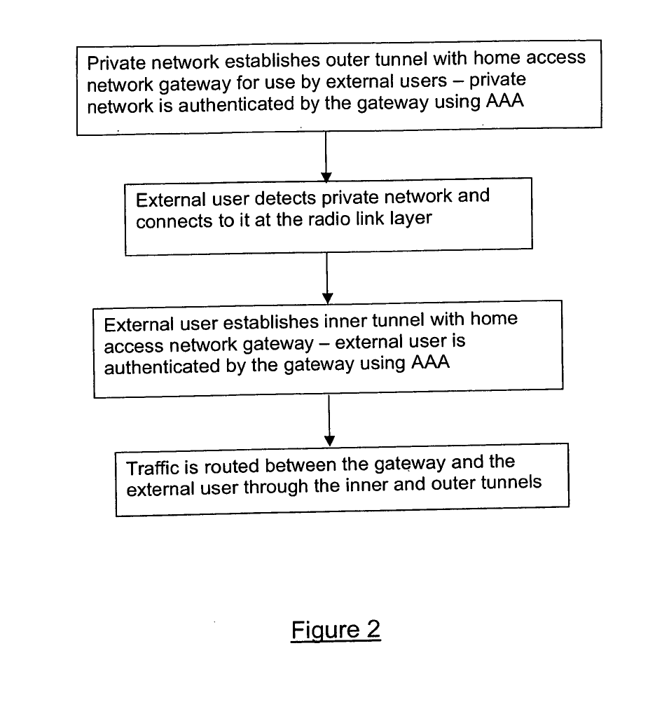

Prior to routing any externally related traffic through the outer tunnel however, an external user must be authenticated to the gateway within the public access network. This may be done by the gateway contacting the Home Location Register of the associated core network using standard AAA procedures. If the external user belongs to some other network, the gateway must authenticate the external user by contacting the user's home network, again using AAA procedures. Assuming that the authentication is successful, a new IPsec SA pair in IKEv2 is established using the Create Child SA Exchange, and the private network allocates an IP address to the external user. As a result, for each external user, an “inner” tunnel is created within the outer tunnel extending between the user and the gateway. Once the inner tunnel is set up, the external user can start sending traffic to the Internet or other communication network, via the gateway. This is illustrated in FIG. 1, where the private network is illustrated as being a WLAN enabled laptop computer belonging to “Alice”, while the external user making use of Alice's private network is “Nancy”. The communication network to which Nancy gains access is the Internet. Packets are “encapsulated” at the outermost level with the SAs associated with the outer tunnel and at a second level with the SAs associated with the appropriate inner tunnel. The gateway will reject any request received from an external user, through the outer tunnel, to establish a tunnel which is not within the outer tunnel. The flow diagram of FIG. 2 further illustrates this procedure.

As a result of the procedure described above, the public access network used by the private network can associate all traffic passing through it with both a private network and an external user. The public access network can thus determine the amount of external traffic routed by a private network and can apply appropriate compensation to the private network operator (compensation may be monetary, traffic credits, etc). In addition, or alternatively, the public access network may use the access provided by the private network to authorise users of the private network to roam into other private networks (i.e. to enable reciprocal roaming between private networks). At the same time, the public access network will be able to distinguish between traffic originating at the private network and external traffic routed via the public access network. This is important, for example, to facilitate legal interception and to determine responsibility for illegal traffic.

The (inner and outer) tunnels do not always have to be established from scratch after movements of the external users and the private network if that is also mobile. For example, when the private network moves, it may reconnect to its gateway using MOBIKE. MOBIKE is an extension of IKEv2 that allows changing the IP address of the client without recreating the tunnel. Similarly, an external user may keep its existing inner tunnel even when moving to a different private network, as long as the public access network of the private networks is the same (as otherwise a different gateway would be involved).

A set of advertisement mechanisms may be employed at the link layer level to indicate to external users the type of service provided by a private network and under what conditions this is provided. Such advertisements may, for example, provide an indication of the applicable tariffs. An external user attaches to the private network on the basis of the advertisements.

It will be appreciated by the person of skill in the art that various modifications may be made to the above described embodiment without departing from the scope of the present invention.

### REFERENCES

[I-D.ietf-ipsec-ikev2] Kaufman, C., “Internet Key Exchange (IKEv2) Protocol”, draft-ietf-ipsec-ikev2-17 (work in progress), October 2004.
[I-D.ietf-mobike-protocol] Eronen, P., “IKEv2 Mobility and Multihoming Protocol (MOBIKE)”, draft-ietf-mobike-protocol-00 (work in progress), June 2005.
[I-D.arkko-eap-service-identity-auth] Arkko, J. and P. Eronen, “Authenticated Service Identities for the Extensible Authentication Protocol (EAP)”, draft-arkko-eap-service-identity-auth-00 (work in progress), April 2004.
[RFC2865] Rigney, C., Willens, S., Rubens, A., and W. Simpson, “Remote Authentication Dial In User Service (RADIUS)”, RFC 2865, June 2000.
[RFC3588] Calhoun, P., Loughney, J., Guttman, E., Zorn, G., and J. Arkko, “Diameter Base Protocol”, RFC 3588, September 2003.
[RFC3748] Aboba, B., Blunk, L., Vollbrecht, J., Carlson, J., and H. Levkowetz, “Extensible Authentication Protocol (EAP)”, RFC 3748, June 2004.
[I-D.ietf-eap-netsel-problem] Arkko, J. and B. Aboba, “Network Discovery and Selection Problem”, draft-ietf-eap-netsel-problem-01 (work in progress), July 2004.
[3GPP.24.234] 3GPP, “3GPP system to Wireless Local Area Network (WLAN)”

1-13. (canceled)

14. A method of routing traffic between external users and a communication network via a private access network, the method comprising:
establishing a secure outer tunnel between the private access network and a gateway of a public access network to which the private access network is coupled, based upon authentication of the private access network to the public access network, said gateway being coupled to said communication network;
for each external user wishing to connect to said communication network via the private access network, establishing a secure inner tunnel between the user and the gateway based upon authentication of the user to the gateway, the inner tunnel being within said outer tunnel;
causing traffic to flow between the external users and the gateway through the respective inner tunnels;
within said public access network, using said inner and outer tunnels to determine an amount of external traffic routed by the private access network; and
applying appropriate compensation to an operator of said private access network in dependence upon said determined amount of external traffic.

15. A method according to claim 14, wherein said outer tunnel carries only traffic which travels through the inner tunnels.

16. A method according to claim 14, wherein the private access network can send its own traffic through the outer tunnel, not within an inner tunnel.

17. A method according to claim 14, wherein said gateway is configured to reject requests to establish secure tunnels with external users which will not pass through said external tunnel.

18. A method according to claim 14, wherein the communication network to which the private access network facilitates access is the Internet.

19. A method according to claim 14, wherein the public access network is a fixed line or cellular telecommunications network.

20. A method according to claim 14, wherein said outer and inner tunnels are IPSec tunnels defined by IKE SAs negotiated between the private access network and a gateway of the public access network and between the external users and that gateway.

21. A method according to claim 14, wherein authentication of an external user to a gateway is performed within said public access network, or involves the public access network communicating with a further network where the user is a subscriber of that further network.

22. A method according to claim 14, wherein said private access network is a single node attached to the public access network via a wireless or wired connection.

23. A method according to claim 14, wherein said private access network is a private wireless network.

24. A gateway for controlling access by external users to a communication network, the gateway being located within a public access network, the gateway comprising:
means for establishing a secure outer tunnel between a private access network and the gateway;
means for establishing a secure inner tunnel between each external user wishing to connect to said communication network via the private access network and the gateway based upon authentication of the user to the gateway, the inner tunnel being within said outer tunnel; and
means for associating traffic travelling through an inner tunnel with a corresponding external user and with the private access network and for determining an amount of external traffic routed by the private access network.

25. A gateway according to claim 24 and comprising means for rejecting requests to establish secure tunnels with external users which will not pass through said external tunnel.
